(19) United States
(12) Patent Application Publication
(10) Pub. No.: US 2025/0209211 A1
(43) Pub. Date: Jun. 26, 2025

(54) METHOD FOR VERIFYING TIMESTAMPS DELIVERED BY A TRAFFIC ENFORCEMENT UNIT

(71) Applicant: IDEMIA IDENTITY & SECURITY FRANCE, Courbevoie (FR)

(72) Inventors: Damien MORICEAU, Courbevoie (FR); Jean-Thomas FERRERI, Courbevoie (FR); Pascal DERGANE, Courbevoie (FR)

(73) Assignee: IDEMIA IDENTITY & SECURITY FRANCE, Courbevoie (FR)

(21) Appl. No.: 18/935,920

(22) Filed: Nov. 4, 2024

(30) Foreign Application Priority Data
Dec. 21, 2023 (FR) 2314933

(51) Int. Cl. G06F 21/64; G06Q 50/26

(52) U.S. Cl. CPC G06F 21/64; G06Q 50/265; G06F 2221/2151

(57) ABSTRACT

A computer-implemented method comprising obtaining an image timestamp indicating a time of acquisition, by a traffic enforcement unit, of an image showing a license plate of a vehicle, the image timestamp having been indicated by a clock of the traffic enforcement unit; obtaining temporal synchronization data, said temporal synchronization data having been received by the traffic enforcement unit during a predefined time interval including the image timestamp with a view to temporal synchronization of the clock of the traffic enforcement unit with a time server; and testing the consistency of the image timestamp with the temporal synchronization data, the consistency test producing a test result indicating whether the image timestamp is valid or invalid.

### FIELD OF THE INVENTION

The present disclosure relates to a method for verifying timestamps delivered by a traffic enforcement unit.

### PRIOR ART

In order to check that the speed of vehicles traveling on a road does not exceed a maximum authorized speed, it is known to use a traffic enforcement system comprising a pair of traffic enforcement units, placed at a distance from each other along the road.

Each of the two traffic enforcement units acquires an image showing the license plate of a vehicle traveling on the road. Two images are thus acquired in succession.

One way to estimate the speed of the vehicle featuring in the two images is to divide the distance between the two traffic enforcement units, which is known in advance, by the length of time separating the times at which the two images were acquired.

To identify these two times, the traffic enforcement units rely on their respective internal clocks, which measure the time that has elapsed.

However, such internal clocks are not always reliable. Therefore, the times of acquisition of the two images may be poorly evaluated by the traffic enforcement units, and this may lead to an inaccurate estimation of the speed of the vehicle featuring in the images.

To compensate for the lack of reliability of the internal clocks, one solution could consist in synchronizing these internal clocks with a remote time server, delivering a time reference deemed reliable. A traffic enforcement unit could thus regularly send synchronization requests to the time server, and the time server return synchronization data to the traffic enforcement unit, to allow the unit to synchronize with the time server.

However, this solution remains imperfect. When an image is acquired by the traffic enforcement unit a relatively long time after the last synchronization (for example very shortly before the next synchronization), it is possible that the internal clock of the unit will have drifted sufficiently to negatively affect the accuracy of a speed to be subsequently estimated.

### DESCRIPTION OF THE INVENTION

One aim of the present disclosure is to detect a situation liable to lead to a poor estimation of a speed using a traffic enforcement unit.

This aim is achieved by way of a computer-implemented method comprising the following steps: obtaining an image timestamp indicating a time of acquisition, by a traffic enforcement unit, of an image showing a license plate of a vehicle, the image timestamp having been indicated by a clock of the traffic enforcement unit; obtaining temporal synchronization data, said temporal synchronization data having been received by the traffic enforcement unit during a predefined time interval including the image timestamp with a view to temporal synchronization of the clock of the traffic enforcement unit with a time server; and testing the consistency of the image timestamp with the temporal synchronization data, the consistency test producing a test result indicating whether the image timestamp is valid or invalid.

This method is a first subject of the present disclosure and may also comprise the following optional features, implemented alone or in any technically meaningful combination.

Optionally, the temporal synchronization data comprise a first value relating to a first synchronization parameter, and the consistency test comprises a comparison between a value to be tested and a first predefined threshold, and the test result indicates that the timestamp is invalid when the value to be tested is greater than the first predefined threshold, the value to be tested being the first value or a corrected value resulting from a correction of the first value made using the temporal synchronization data.

Optionally, the temporal synchronization data comprise a sequence of first values relating to the first synchronization parameter, the first values having been received sequentially by the traffic enforcement unit during the predefined time interval, and the method comprises selection of an extreme value from the sequence of first values, the first predefined threshold being selectively compared with the extreme value or with a corrected extreme value resulting from a correction of the extreme value made using the temporal synchronization data.

Optionally, the first values comprise at least one value received by the traffic enforcement unit before acquisition of the image, and at least one other value received by the traffic enforcement unit after acquisition of the image.

Optionally, the temporal synchronization data comprise a sequence of datasets, the datasets having been received sequentially by the traffic enforcement unit during the predefined time interval, the datasets comprising respective first values relating to the first synchronization parameter and respective second values relating to a second synchronization parameter different from the first synchronization parameter, and the method comprises steps of: preselecting, from the sequence of datasets, datasets the respective second values of which are not greater in absolute value than a second predefined threshold; and selecting an extreme value among the respective first values of the preselected datasets, the first predefined threshold being selectively compared with the extreme value or with a corrected extreme value resulting from a correction of the extreme value made using the temporal synchronization data.

Optionally, the temporal synchronization data comprise a second value relating to a second synchronization parameter different from the first synchronization parameter, the consistency test comprising a comparison between another value to be tested and a second predefined threshold, the other value to be tested being the second value or another corrected value resulting from a correction of the second value using the temporal synchronization data. The test result indicates that the timestamp is invalid when at least one of the following two conditions is met: the value to be tested is greater than the first predefined threshold, and the other value to be tested is greater than the second predefined threshold.

Optionally, the second synchronization parameter is a time jitter representative of a variation in network latency between the clock of the traffic enforcement unit and the time server.

Optionally, the first synchronization parameter is a time offset between the clock of the traffic enforcement unit and the time server.

Optionally, the correction of a value relating to a synchronization parameter using the temporal synchronization data comprises subtracting from said value an average of time offsets between the clock of the traffic enforcement unit and the time server, or even subtracting from said value a minimum jitter during the time interval.

Optionally, the predefined time interval has a duration greater than a time period used by the traffic enforcement unit to periodically request temporal synchronization data from the time server.

Optionally, the method comprises estimating a speed of the vehicle based on a predefined distance between the traffic enforcement unit and another traffic enforcement unit, and on a length of time between the image timestamp and another image timestamp, the other image timestamp indicating a time of acquisition, by the other traffic enforcement unit, of another image showing the license plate of the vehicle.

A second subject of the present disclosure is a computer program product comprising program code instructions for executing the steps of the method forming the first subject of the disclosure, when the program is executed by a computer.

This program may use any programming language (for example an object language or the like) and take the form of an interpretable source code, of a partially compiled code or of a fully compiled code.

A third subject of the present disclosure is further a computer-readable non-transient recording medium on which there is recorded a computer program product comprising code instructions for implementing the steps of the method forming the first subject of the disclosure when the program is executed by a computer.

A fourth subject of the present disclosure is a system comprising: a traffic enforcement unit and a processor. The traffic enforcement unit comprises: a radar, a camera configured to acquire an image showing a license plate of a vehicle, a clock configured to produce an image timestamp indicating a time of acquisition, by the traffic enforcement unit, of the image, and a communication interface for receiving temporal synchronization data during a predefined time interval including the image timestamp, the temporal synchronization data being delivered by a time server, and being suitable for synchronizing temporally the clock of the traffic enforcement unit with the time server. The processor is configured to test the consistency of the image timestamp with the temporal synchronization data, the consistency test producing a test result indicating whether the image timestamp is valid or invalid.

### DESCRIPTION OF THE FIGURES

FIG. 1 schematically illustrates a system according to one embodiment.

FIG. 2 shows the internal components of a traffic enforcement unit and of an enforcement server, according to one embodiment.

FIG. 3 is a flowchart of steps of a method implemented by a traffic enforcement unit, according to one embodiment.

FIG. 4 is a flowchart of steps of a method implemented by an enforcement server, according to one embodiment.

FIG. 5a, FIG. 5b and FIG. 5c are flowcharts constituting three different embodiments of a consistency-testing step implemented by an enforcement server.

In all of the figures, elements that are similar have been designated by identical references.

### DETAILED DESCRIPTION OF THE INVENTION

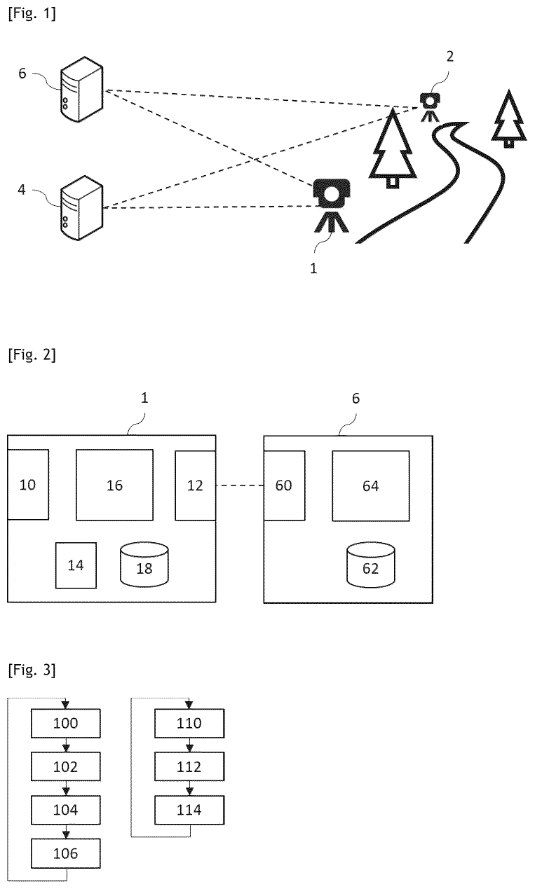

FIG. 1 shows a system comprising a first traffic enforcement unit 1, a second traffic enforcement unit 2, a time server 4 and an enforcement server 6.

The first traffic enforcement unit 1 and the second traffic enforcement unit 2 are positioned along a road, so that a vehicle traveling on the road passes close to the first traffic enforcement unit 1, then close to the second traffic enforcement unit 2. The distance separating the two traffic enforcement units is known.

With reference to FIG. 2, the first traffic enforcement unit 1 comprises a radar (not shown), for example a Doppler radar, a camera 10, a network communication interface 12, a clock 14, a processor 16 and a memory 18.

The camera 10 is configured to acquire images showing the license plate of vehicles traveling on the road.

The network communication interface 12 is configured to communicate with the time server 4 (not shown in FIG. 2) and the enforcement server 6. The network communication interface 12 is of any type, either a wired interface (for example an Ethernet interface) or a wireless interface (cellular interface, Wi-Fi interface, etc.).

The clock 14 is configured to provide timestamps indicating the times at which certain events detected by the traffic enforcement unit 1 occurred. These events will be described below.

The processor 16 is configured to get the network communication interface 12 to send synchronization requests to the time server 4, and to do so periodically.

The processor 16 is also configured to synchronize the clock 14 using a set of synchronization data sent by the time server 4 then received by the network communication interface 12, in response to a synchronization request. The objective of the synchronization, such synchronization being known in the art, is to reset the clock 14 so that the time measured by the clock corresponds to a time measured by the time server. Thus, a synchronization might put the time measured by the clock 14 forward or back, if perchance the clock 14 had drifted with respect to the time server since a previous synchronization.

A conventional synchronization dataset contains the parameters listed in the table below.

TABLE 1

| Parameter | Definition |
|---|---|
| Delay | The average length of time between when a synchronization |
| | request is sent and receipt of a synchronization dataset |
| | in response to the synchronization request. |
| Time | Average time difference between the clock and the time |
| offset | server. |
| Jitter | Represents a variation in network latency between the clock |
| | and the time server. |

The memory 18 is configured to store received synchronization data and images acquired by the camera 10. The memory 18 is in particular configured to store these data and images classified in order of time, by assigning them timestamps delivered by the clock 14. The memory 18 may be of any type, for example a flash memory, an electrically-erasable programmable read-only memory (EEPROM), a hard disk drive (HDD), a solid-state drive (SSD), etc. The memory is or comprises a computer-readable non-transient recording medium.

The second traffic enforcement unit 2 comprises the same components as those described above in respect of the first traffic enforcement unit 1.

The time server 4 is a time reference. How it works is known in the art. For example, the time server 4 is an NTP server, this meaning that the communications between each traffic enforcement unit 1, 2 and the time server 4, and the synchronization computations carried out by the traffic enforcement radars 1, 2, are in accordance with the NTP protocol (NTP standing for Network Time Protocol).

Still with reference to FIG. 2, the enforcement server 6 comprises a network communication interface 60, a memory 62 and a processor 64.

The network communication interface 60 is configured to communicate with each traffic enforcement unit 1, 2. It is of any type, for example any of the types mentioned above in respect of the network communication interface 12.

The memory 62 is configured to store data received via the network communication interface 60 or produced by the processor 64.

The processor 64 is configured to process data received via the network communication interface 60 or stored by the memory 62. These processing operations will be described below.

With reference to FIG. 3, a method implemented by the traffic enforcement unit 1 comprises the following steps.

In a step 100, the processor 16 asks for a synchronization request to be sent to the time server 4 via the network communication interface 12.

In a step 102, the processor 16 detects receipt, by the network communication interface 12, of a synchronization dataset from the time server 4, in response to the synchronization request.

In a step 104, the processor 16 synchronizes the clock 14 of the traffic enforcement unit 1 using the received synchronization dataset.

In a step 106, the processor 16 asks for the synchronization dataset, in association with a timestamp delivered by the clock 14, to be transmitted to the enforcement server 6, via the network communication interface 12, the timestamp indicating the time of receipt of the synchronization dataset (therefore when step 102 occurred) or the time of synchronization of the clock 14 using the synchronization data. By convention, such a timestamp is referred to below as a “synchronization timestamp”.

The above steps are repeated over time. In particular, sending step 100 is triggered periodically.

The method implemented by the traffic enforcement unit 1 moreover comprises the following steps.

In a step 110, the traffic enforcement unit 1 detects passage of a vehicle through the field of view of its camera 10, using appropriate detecting means (known to those skilled in the art).

In a step 112, the camera 10 acquires an image showing a license plate of the detected vehicle.

In a step 114, the processor 16 asks for a timestamp indicating the time of acquisition of the image by the camera 10 to be transmitted to the enforcement server 6, via the network communication interface 12, this timestamp having been indicated by the clock 14. By convention, such a timestamp is referred to below as an “image timestamp”, to differentiate this timestamp from synchronization timestamps. The processor 16 may also send the acquired image to the enforcement server 6 in association with the image timestamp related thereto.

The preceding steps are also repeated over time, for a plurality of vehicles traveling on the road.

Repeated implementation of the transmitting steps 106 and 114 leads the traffic enforcement unit 1 to transmit timestamps T1 . . . . TN to the enforcement server 6. The N timestamps form an ordered sequence. By convention, T1 is the oldest timestamp, and TN is the most recent timestamp. As indicated above, each timestamp Ti is either an image timestamp, this meaning that this timestamp indicates the time of acquisition of an image by the camera 10 of the traffic enforcement unit 1, or a synchronization timestamp, this meaning that this timestamp is associated with a synchronization dataset Si, also delivered to the enforcement server 6.

The table below contains one example of 7 successive timestamps T1 to T7, forming a sequence. T1 and T4 are image timestamps in this example. The others Ti are synchronization timestamps, and are therefore associated with respective synchronization datasets Si.

TABLE 2

| | |
|---|---|
| T1 | (image timestamp) |
| T2 | S2 |
| T3 | S3 |
| T4 | (image timestamp) |
| T5 | S4 |
| T6 | S5 |
| T7 | S6 |

Of course, these data may be transmitted to the enforcement server 6 synchronously, or indeed in non-real time, so as to group the transmissions. In the second case, the data transmitted to the enforcement server 6 may be temporarily stored in the memory 18 of the traffic enforcement unit 1.

The above method is also implemented by the second traffic enforcement unit 2.

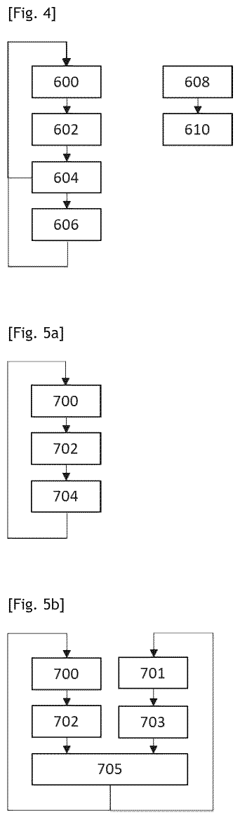

With reference to FIG. 4, a method implemented by the enforcement server 6 to verify the data delivered by the first traffic enforcement unit 1 will now be described.

It is assumed at this stage that the timestamps T1 to TN delivered by the first traffic enforcement unit 1 have been received by the network communication interface 60 of the enforcement server 6, just like each synchronization dataset Si associated with a synchronization timestamp.

In a step 600, the processor 64 obtains an image timestamp Ti indicating the time of acquisition, by the traffic enforcement unit 1, of the image. This timestamp is typically obtained by reading the memory 62.

In a step 602, the processor 64 obtains temporal synchronization data that were received by the traffic enforcement unit 1 during a predefined time interval [Ta, Tb] including the image timestamp Ti. Therefore Ta<Ti≤Tb.

In one embodiment, the predefined time interval has a predefined duration ΔT, such that ×T=Tb−Ta. Moreover, the temporal position of the bounds Ta, Tb of the interval with respect to the image timestamp Ti is also predefined. For example, the time interval is centered on the image timestamp. In this case, the predefined time interval takes the form [Ta, Tb]=[Ti−ΔT/2, Ti+ΔT/2].

To obtain the temporal synchronization data received by the traffic enforcement unit 1 during the predefined time interval [Ta, Tb], the processor 64 compares each synchronization timestamp present in the memory 62 and having originated from the traffic enforcement unit 1, with the predefined time interval. If a synchronization timestamp has a value comprised in [Ta, Tb], then this timestamp is retained.

In a step 604, the processor 64 tests the consistency of the image timestamp with the synchronization data received by the traffic enforcement unit 1 during the predefined time interval. The consistency test produces a result that indicates either that the image timestamp is valid (in the case where it is considered during the test to be consistent with the obtained synchronization data), or that the image timestamp is invalid (in the contrary case where it is considered during the test to be inconsistent with the obtained synchronization data).

When the result indicates that the image timestamp is valid, the processor 64 may implement a step 606 of correcting this image timestamp on the basis of the synchronization data. This step is not implemented when the result indicates that the image timestamp is invalid.

The correction made in step 606 may solely use an average of the time offsets observed in the range [Ta, Tb], as follows:

Timestamp_corrected=timestamp+average(offsets)

As a variant, a similar reasoning may be applied for time jitter. A possible correction would then consist in searching for the minimum value (MIN(abs(JITTER)) observed in the range, then in adding it to the image timestamp in question. Specifically, if in the range a “network latency” of x microseconds is observed, it may then be estimated that the image timestamp has been delayed by this latency. Thus:

Timestamp_corrected=timestamp+average(offset)+MIN(abs(jitter))

The preceding steps are repeated by the enforcement server 6 for various image timestamps, or even all the image timestamps that the enforcement server 6 receives from the traffic enforcement unit 1.

The enforcement server 6 repeats the same steps on the data delivered by the second traffic enforcement unit 2. In other words, the enforcement server 6 tests the consistency of the image timestamp delivered by the second traffic enforcement unit 2.

Various embodiments of the consistency test applied by the processor 64 will now be described in detail.

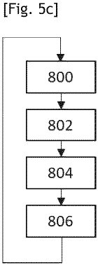

In a first embodiment, with reference to FIG. 5a, the consistency test uses solely a first synchronization parameter.

Each synchronization dataset Si, associated with a synchronization timestamp Ti, comprises (or even consists of) a value relating to this first synchronization parameter.

Thus, the synchronization data that the enforcement server 6 obtained in step 602 (which were received upstream by the traffic enforcement unit 1 during the predefined time interval [Ta, Tb] that included the image timestamp undergoing the consistency test) comprise a sequence of first values relating to the first synchronization parameter (offset), the first time values having been received sequentially by the traffic enforcement unit 1 during this time interval.

Preferably, the first values comprise at least one value received by the traffic enforcement unit 1 before acquisition of the image, and at least one other value received by the traffic enforcement unit 1 after acquisition of the image.

In a step 700, the processor 64 selects an extreme value from the sequence of first values. The extreme value is in absolute value a maximum value. This means that when the first values are signed, then the extreme value is the maximum of the respective absolute values of the first values.

In a step 702, the processor 64 compares the extreme value with a first predefined threshold.

Preferably, the first predefined threshold is selectively compared with the extreme value. This means that not all the other first values of the sequence are compared with the first threshold. Only one comparison is made in step 702. This makes it possible to save computational resources.

In a step 704, the processor 64 generates the test result on the basis of the comparison 702, by following the following logic:

The test result indicates that the image timestamp is invalid when the extreme value is greater than the first predefined threshold.

The test result indicates that the image timestamp is valid when the extreme value is not greater than the first predefined threshold.

For example, the first synchronization parameter is the time offset described above. In this case, the sequence of first values is a sequence of time offsets, and the first predefined threshold is a time-offset threshold selectively compared with a maximum time offset in the time interval [Ta, Tb].

The logic used by the processor 64 to invalidate an image timestamp in this first embodiment may be summarized by the following formula:

max(abs(OFFSET))>offset threshold

By way of illustration of this first embodiment, it is assumed that:
the time-offset threshold is set to 500 milliseconds (it is desired for the clock of the traffic enforcement unit 1 not to be ahead of or behind the clock of the time server 4 by more than 500 ms);
the duration of the time interval [Ta, Tb] is equal to 10 mn, and the image timestamp Ti to be tested is centered on this interval. The interval is then [Ti−5 mn, Ti+5 mn].

The minimum value MIN and maximum value MAX of the time offsets the image timestamps of which fall within this interval are determined. The processor verifies that abs (MAX)<500 ms and that abs(MIN)<500 ms. If abs(MAX)>500 ms or abs(MIN)>500 ms, then the test result is negative (image timestamp inconsistency). Specifically, this situation means that there is a probability that the image timestamp has an offset of more than 500 ms with respect to the time at which the image was actually acquired by the camera 10.

Specifically, the probability that the offset X at the time T (timestamp of the unit) is greater than the threshold of 500 ms may be approximated by a Gaussian distribution:

P(X>500 ms)=1−F((500−u)/s)
where:
u=average of the offsets measured in the range;
s=standard deviation of the offsets measured in the range;
F=distribution function of the standard normal distribution.

In the case where at least one first value (time offset) is greater than the threshold of 500 ms, the average is considered to be less than or equal to this max, and therefore, in a worst case scenario, the average is greater than 500, the standard deviation tends toward zero, and therefore the probability tends toward 1. It may therefore legitimately be considered that using the extreme value makes it possible to identify the case where there is a non-zero probability of the offset of the timestamp T exceeding the first predefined threshold.

If none of the first values is greater than 500 ms, then the MAX is less than 500 ms, and the probability that the acquisition of the image occurred at a time offset by more than 500 ms with respect to the retrieved image timestamp becomes negligible.

In a second embodiment, with reference to FIG. 5b, the consistency test uses not only the first synchronization parameter discussed above, but also a second synchronization parameter different from the first synchronization parameter.

Each synchronization dataset Si, associated with the synchronization timestamp Ti, thus contains:
a value relating to the first synchronization parameter, and
a value relating to the second synchronization parameter.

Thus, the synchronization data that the enforcement server 6 obtained in step 602 (which were received upstream by the traffic enforcement unit 1 during the predefined time interval [Ta, Tb] that included the image timestamp undergoing the consistency test) comprise a sequence of datasets Si, in which the datasets contain:
respective first values relating to the first synchronization parameter;
respective second values relating to the second synchronization parameter.

Preferably, the datasets Si comprise at least one set received by the traffic enforcement unit 1 before acquisition of the image, and at least one other set received by the traffic enforcement unit 1 after acquisition of the image.

Steps 700 and 702 of the first embodiment are also implemented in the second embodiment, with the first synchronization parameter.

Furthermore, in a step 701, the processor selects a second extreme value from the sequence of second values. The extreme value is in absolute value a maximum value. This means that when the second values are signed, then the extreme value is the maximum of the respective absolute values of the second values.

In a step 703, the processor compares the second extreme value with a second predefined threshold.

Preferably, the second predefined threshold is selectively compared with the second extreme value. This means that not all the other second values of the sequence are compared with the second threshold. This makes it possible to save computational resources.

Essentially, steps 701 and 703 are steps similar to steps 700 and 702, except that they relate to the second synchronization parameter.

In a step 705, the processor generates the test result based on the comparisons made in steps 702 and 703, as follows:

The test result indicates that the image timestamp is invalid when at least one of the following two conditions is met:
the first value is greater than the first predefined threshold, or
the second value is greater than the second predefined threshold.

The test result indicates that the image timestamp is valid when both the following conditions are met:
the first value is not greater than the first predefined threshold, and
the second value is not greater than the second predefined threshold.

For example, the first synchronization parameter is the time offset described above, and the second synchronization parameter is the jitter also described above. In this case:
the sequence of first values is a sequence of time offsets, and the first predefined threshold is a time-offset threshold selectively compared with a maximum time offset in the time interval [Ta, Tb], and
the sequence of second values is a sequence of jitters, and the second predefined threshold is a jitter threshold selectively compared with a maximum jitter in the time interval [Ta, Tb].

The logic used to make a conclusion in respect of the invalidity of the image timestamp in this second embodiment may be expressed as follows:

max(abs(OFFSET))>offset threshold or max(abs(JITTER))>jitter threshold

In a third embodiment illustrated in FIG. 5c, the consistency test uses a first synchronization parameter and a different second synchronization parameter.

As in the second embodiment, the synchronization data that the enforcement server 6 obtained in step 602 (which were received upstream by the traffic enforcement unit 1 during the predefined time interval [Ta, Tb] that included the image timestamp undergoing the consistency test) comprise a sequence of datasets Si, in which the datasets contain:
respective first values relating to the first synchronization parameter,
respective second values relating to the second synchronization parameter.

However, it will be seen that the second synchronization parameter plays a role that is asymmetrical to the role of the first synchronization parameter, as was the case in the second embodiment.

In a step 800, the processor 64 preselects, from the sequence of datasets, datasets the respective second values of which are not greater in absolute value than a second predefined threshold. The result of this preselection is therefore a subset of the input sequence (certain datasets have been removed).

In a step 802, the processor 64 selects an extreme value from among the respective first values of the preselected datasets. This selection step 802 is similar to step 700, except that this selection 802 receives as input the result of the preselection 800.

In a step 804, the processor 64 compares the extreme value with a first predefined threshold.

In a step 806, the processor generates the test result on the basis of this comparison:
the test result indicates that the image timestamp is invalid when the extreme value is greater than the first predefined threshold;
the test result indicates that the timestamp is valid when the extreme value is not greater than the first predefined threshold.

Preferably, the first predefined threshold is selectively compared with the extreme value. This means that not all the other first values of the sequence are compared with the first threshold. This makes it possible to save computational resources.

For example, the first synchronization parameter is the time offset described above, and the second synchronization parameter is the jitter also described above. In this case:
The sequence of first values is a sequence of time offsets, and the first predefined threshold is a time-offset threshold selectively compared with a maximum time offset in the time interval [Ta, Tb], and
The sequence of second values is a sequence of jitters, and the second predefined threshold is a jitter threshold selectively compared with a maximum jitter in the time interval [Ta, Tb].

To illustrate this third embodiment, let an example be considered in which:
the time-offset threshold is set to 500 milliseconds (it is desired for the clock of the unit not to be ahead of or behind the clock of the time server by more than 500 ms);
the duration of the time interval [Ta, Tb] is equal to 10 mn, and the image timestamp Ti to be tested is centered on this interval. The interval is then [Ti-5 mn, Ti+5 mn];
the jitter threshold is 1 millisecond.

The implemented algorithm then consists in filtering in this interval measurements with a jitter greater than 1 millisecond in absolute value. For the remaining values, i.e. those that were preselected, the processor checks whether the following condition is met:

max(abs(OFFSET))>offset threshold

Essentially, the third embodiment may be seen as an extension of the first embodiment, incorporating an additional preselecting step allowing first values (time offsets) associated with aberrant second values (jitters) to be filtered out.

With reference to FIG. 4, the enforcement server 6 may also implement the following steps, after having obtained synchronization data from the first traffic enforcement unit 1 and from the second traffic enforcement unit 2.

In a step 608, the processor 64 detects that the following conditions are met:
an image timestamp delivered by the first traffic enforcement unit 1 shows a license plate of a vehicle;
another image timestamp, delivered by the second traffic enforcement unit 2, shows the license plate of the same vehicle.

In a step 610, the processor 64 estimates a speed of the vehicle based on the following data:
the distance between the first traffic enforcement unit 1 and the second traffic enforcement unit 2, which is known in advance;
the length of time that passed between the image timestamp (delivered by the first traffic enforcement unit 1) and the other image timestamp (delivered by the second traffic enforcement unit 2).

Step 610 may be implemented each time the conditions of step 608 are met. As a variant, step 610 may be implemented only if the image timestamp and the other image timestamp have been declared valid during respective consistency tests 604, or if these timestamps were corrected in step 606 (if the latter is implemented by the enforcement server 6). In other words, the processor 64 does not estimate a speed based on an image timestamp declared invalid during the consistency test 604.

In the embodiments discussed above, the consistency test applied to image timestamps obtained from the traffic enforcement unit 1 is carried out by an entity remote from the first traffic enforcement unit 1, namely an enforcement server 6. As a variant, the consistency test is carried out by the processor 16 of the first traffic enforcement unit 1.

In the embodiments discussed above, the enforcement server 6 may be given the task of estimating vehicle speeds. This is not mandatory. The test of the consistency of the timestamps and the subsequent steps of estimating vehicle speeds may be implemented by different entities, for example two separate servers.

In the embodiments discussed above, it was assumed that the predefined time interval was defined by its duration. This is not mandatory. As a variant, the predefined time interval could be defined by its size, expressed in number of timestamps. For example, as time interval an interval containing K synchronization timestamps prior to the image timestamp to be tested, and K synchronization timestamps subsequent to the image timestamp to be tested, may be chosen. Thus, the total number of synchronization timestamps taken into account is equal to 2K. When an extremum is selected, this extremum is thus selected from a set of 2K values (or optionally a subset in the third embodiment incorporating preselection).

In the embodiments discussed above, it has been assumed that the image timestamps obtained from both traffic enforcement units 1, 2 are tested, or even corrected. However, it is enough to carry out these steps on one of the two traffic enforcement units to improve the situation described in the introductory part.

In the embodiments discussed above, the thresholds used (first threshold or second threshold) are compared with values that form part of the temporal synchronization data delivered by one of the two traffic enforcement units. It has moreover been envisioned to correct image timestamps that successfully pass the consistency test, and therefore after this consistency test, by adding a corrective term to them. However, another strategy may consist in correcting the values intended to be compared with either of the thresholds using the temporal synchronization data, by subtracting this corrective term from them.

For example, in a variant of the consistency test according to the first embodiment, the extreme value in the sequence of first values is replaced by a corrected version of this extreme value. This correction may consist in subtracting from the extreme value the average of the time offsets between the clock of the traffic enforcement unit and the time server in the time interval in question. Thus, the value to be compared with the threshold changes from the form “MAX(abs(OFFSET))” to the form “MAX(abs(OFFSET-average (offsets)))”. Another more advanced correction may also subtract the minimum jitter during the time interval. The compared value is then of the form “MAX(abs(OFFSET−average (offset)-MIN(abs(JITTER)))”.

Of course, the consistency test according to the second embodiment and the consistency test according to the third embodiment may be the subject of similar variants involving correction before comparison with a threshold.

1. A computer-implemented method, comprising steps of:
obtaining an image timestamp indicating a time of acquisition, by a traffic enforcement unit, of an image showing a license plate of a vehicle, the image timestamp having been indicated by a clock of the traffic enforcement unit,
obtaining temporal synchronization data, said temporal synchronization data having been received by the traffic enforcement unit during a predefined time interval including the image timestamp with a view to temporal synchronization of the clock of the traffic enforcement unit with a time server, and
testing the consistency of the image timestamp with the temporal synchronization data, the consistency test producing a test result indicating whether the image timestamp is valid or invalid.

2. The method as claimed in claim 1, wherein:
the temporal synchronization data comprise a first value relating to a first synchronization parameter, and
the consistency test comprises a comparison between a value to be tested and a first predefined threshold, and the test result indicates that the timestamp is invalid when the value to be tested is greater than the first predefined threshold, the value to be tested being the first value or a corrected value resulting from a correction of the first value made using the temporal synchronization data.

3. The method as claimed in claim 2, wherein:
the temporal synchronization data comprise a sequence of first values relating to the first synchronization parameter, the first values having been received sequentially by the traffic enforcement unit during the predefined time interval, and
the method further comprises selecting an extreme value from the sequence of first values, and wherein the first predefined threshold is selectively compared with the extreme value or with a corrected extreme value resulting from a correction of the extreme value made using the temporal synchronization data.

4. The method as claimed in claim 3, wherein the first values comprise at least one value received by the traffic enforcement unit before acquisition of the image, and at least one other value received by the traffic enforcement unit after acquisition of the image.

5. The method as claimed in claim 2, wherein:
the temporal synchronization data comprise a sequence of datasets, the datasets having been received sequentially by the traffic enforcement unit during the predefined time interval, wherein the datasets comprise:
respective first values relating to the first synchronization parameter, and
respective second values relating to a second synchronization parameter different from the first synchronization parameter, and
the method further comprises:
preselecting, from the sequence of datasets, datasets the respective second values of which are not greater in absolute value than a second predefined threshold, and
selecting an extreme value among the respective first values of the preselected datasets, and wherein the first predefined threshold is selectively compared with the extreme value or with a corrected extreme value resulting from a correction of the extreme value made using the temporal synchronization data.

6. The method as claimed in claim 2, wherein:
the temporal synchronization data comprise a second value relating to a second synchronization parameter different from the first synchronization parameter,
the consistency test comprises a comparison between another value to be tested and a second predefined threshold, the other value to be tested being the second value or another corrected value resulting from a correction of the second value using the temporal synchronization data, and
the test result indicates that the timestamp is invalid when at least one of the following two conditions is met:
the value to be tested is greater than the first predefined threshold, and
the other value to be tested is greater than the second predefined threshold.

7. The method as claimed in claim 5, wherein the second synchronization parameter is a time jitter representative of a variation in network latency between the clock of the traffic enforcement unit and the time server.

8. The method as claimed in claim 2, wherein the first synchronization parameter is a time offset between the clock of the traffic enforcement unit and the time server.

9. The method as claimed in claim 2, wherein the correction of a value relating to a synchronization parameter using the temporal synchronization data comprises subtracting from said value an average of time offsets between the clock of the traffic enforcement unit and the time server.

10. The method as claimed in claim 9, wherein the correction of the value relating to a synchronization parameter using the temporal synchronization data comprises subtracting from said value a minimum jitter during the time interval.

11. The method as claimed in claim 1, wherein the predefined time interval has a duration greater than a time period used by the traffic enforcement unit to periodically request temporal synchronization data from the time server.

12. The method as claimed in claim 1, further comprising:
estimating a speed of the vehicle based on a predefined distance between the traffic enforcement unit and another traffic enforcement unit, and on a length of time between the image timestamp and another image timestamp, the other image timestamp indicating a time of acquisition, by the other traffic enforcement unit, of another image showing the license plate of the vehicle.

13. (canceled)

14. A non-transitory computer-readable recording medium on which is recorded a computer program product comprising code instructions for implementing the method as claimed in claim 1, when the program is executed by a computer.

15. A system, comprising:
a traffic enforcement unit comprising:
a radar;
a camera configured to acquire an image showing a license plate of a vehicle,
a clock configured to produce an image timestamp indicating a time of acquisition, by the traffic enforcement unit, of the image, and
a communication interface for receiving temporal synchronization data during a predefined time interval including the image timestamp, the temporal synchronization data being delivered by a time server, and being suitable for synchronizing temporally the clock of the traffic enforcement unit with the time server, and
a processor configured to test a consistency of the image timestamp with the temporal synchronization data, the consistency test producing a test result indicating whether the image timestamp is valid or invalid.
